(19) United States
(12) Patent Application Publication
(10) Pub. No.: US 2003/0079977 A1
(43) Pub. Date: May 1, 2003

(54) Suspension cord pull switch

(76) Inventor: Jung-Tsung Wei, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/984,111

(22) Filed: Oct. 29, 2001

(51) Int. Cl. H01H 3/20

(52) U.S. Cl. 200/331

(57) ABSTRACT

An innovated suspension cord pull switch, having a capacitive induction device, serving as a touch control with capacitive induction effect; wherein a capacitive sensor or device is connected to a suspension pull cord, so the suspension pull cord becomes a touch-type or non-touch control device having a sensor effect. Instead of conventional pulling operation, grasping operation, restricted direction of operation, and the extent of force in operation, the switch can be operated more easily, conveniently and quickly.

### BACKGROUND OF THE INVENTION

(a) Field of the Invention

The invention relates to a suspension cord pull switch, having a capacitive induction effect for easier and more convenient operation of the switch, , instead of conventional operation involving manual grasping, aiming of direction, and control of extent of force.

(b) Description of the Prior Art

Conventional suspension chain (string-pulling) switches have been widely used by people for the past 40 or 50 years, because they have some advantages. The object hanging high above has a low trouble rate, is convenient for operation, has a height of suspended string that can be adjusted freely to suit the position of the switch. The suspended switch can suit the needs of various circumstances. Another important reason for the popular use of the conventional suspended chain or pull string switch lies in that: the suspended string of switch hangs in midair, showing its conspicuous position for operation. Therefore, for a long period of time, people have become accustomed to it. Take the electrical household appliances as example; consumers would often have trouble finding the location of the switches, because the switches are often located at different locations in different appliances. This problem is aggravated because of the wider and wider variety of switches available on the market.

The suspension pull switch has a unique feature among all types of switches. It is conspicuously located for people to see. For the past 40 to 50 years, consumers are familiar with their use and operation. But conventional types of suspension switches have shortcomings that need improvement, including the four steps that must be followed (as shown in FIGS. 1 through 4):

1. The user's fingers must come in contact with the suspension cord 1.

2. The user must firmly grasp the suspension cord 1.

3. After grasping the suspension cord 1, the user must apply a sufficient force to pull the suspension down.

4. Finally, the user releases his fingers from the suspension cord 1.

Such operation requires sophisticated procedures, and is labor and time-consuming, inconvenient and requiring precision. Because, the user could not pull the cord down without correctly locating and grasping the suspension cord 1. Meanwhile, when performing step 3, the suspension cord 1 must be pulled down to effect switching control. If the suspension cord 1 is pulled in an oblique angle, the switch could not be performed correctly, or could not work. Or, the switch may be damaged, and its service life may be shortened. Therefore, conventional type of suspension switch involves the restriction on the direction of operation. (Pulling in a downward direction could not be free from directional restriction.) Secondly, the force applied in pulling the suspension cord 1 must be controlled correctly. In case of excessive pulling force, the switch could be damaged. On the other hand, an insufficient force will not be able to perform the switching function. In the process of grasping the suspension cord 1, if in the first try the user cannot grasp the suspension cord 1 successfully, the suspension cord 1 could jump or swing in every direction conceivable; therefore in many cases the user has to try several times before he can successfully grasp and pull the suspension cord 1 and activate the switch. To prevent the suspension cord 1 from slipping out of hand after the cord is grasped in hand, there is a stopper object 11 installed at the end of the suspension cord 1, to stop the suspension cord 1 from slipping out of hand. But the stopper object 11 do not have other functions except just that.

Therefore, due to the fact that conventional types of suspension pull switches have been widely used, but there are little improvement made on them, it has become imperative to seek possible improvement.

### SUMMARY OF THE INVENTION

Therefore, to overcome the problems of inconvenience and shortcomings of conventional types of suspension pull switches, the inventor has come up with the present invention of suspension cord pull switch involving a capacitive sensor or device, so the suspension pull cord becomes a touch or non-touch control cord having a capacitive induction effect. Thereby, the user can perform effective control merely by touching or not touching the suspension cord. The suspension cord is operated without requiring conventional processes including grasping the cord, restriction on operational directions, and control of force applied. By simple process of one-touch operation, the invention of suspension switch can be operated easily, conveniently and quickly.

To avoid failure of performing anticipated control using a nonconductive insulator to touch the suspension cord, there is a touch unit installed at the end of the suspension cord. Inside the touch unit is installed a contact unit. The touch unit and the contact unit are separated and insulated. One of the touch unit or the contact unit is grounded, while the other is connected with the suspension cord. When an insulator touches the suspension cord or the touch unit, the contact unit is brought in contact with the touch unit, thereby performing the effect of touch control.

The objectives and scope of applications of the present invention can be understood from the following description. But the detailed description and the preferred embodiment provided herein shall not be based to restrict the intent of the present invention. It should be understood that all equivalent modifications or variations made without departing from the description shall be included in the spirit and intent of the subject claim.

### BRIEF DESCRIPTION OF DRAWINGS

FIG. 1 shows the operation of a conventional suspension cord pull switch (1).

FIG. 2 shows the operation of a conventional suspension cord pull switch (2).

FIG. 3 shows the operation of a conventional suspension cord pull switch (3).

FIG. 4 shows the operation of a conventional suspension cord pull switch (4).

FIG. 5 is a perspective view of the invention.

FIG. 6 is another view of the invention.

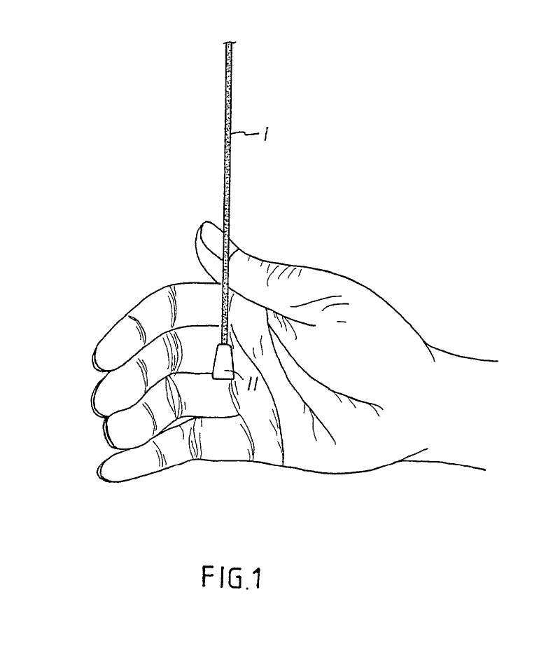

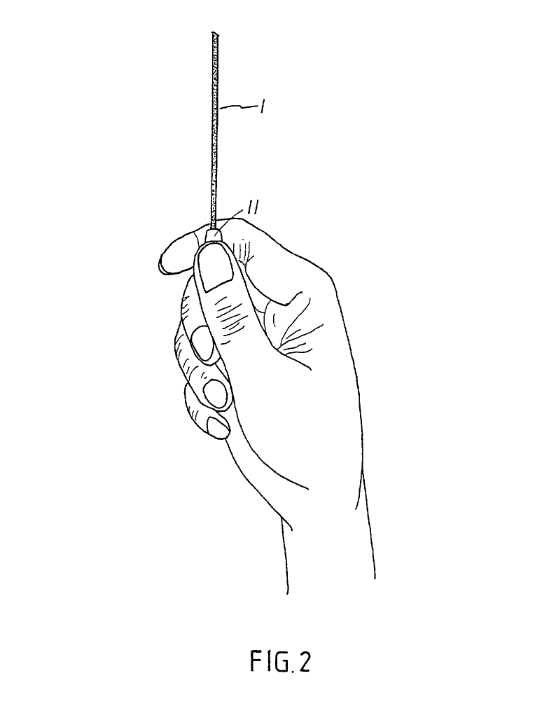

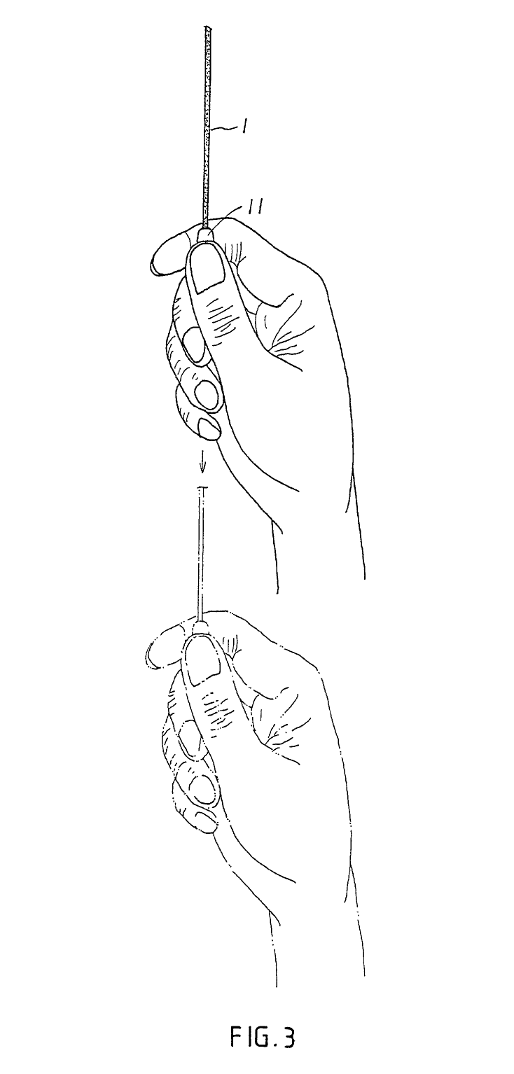

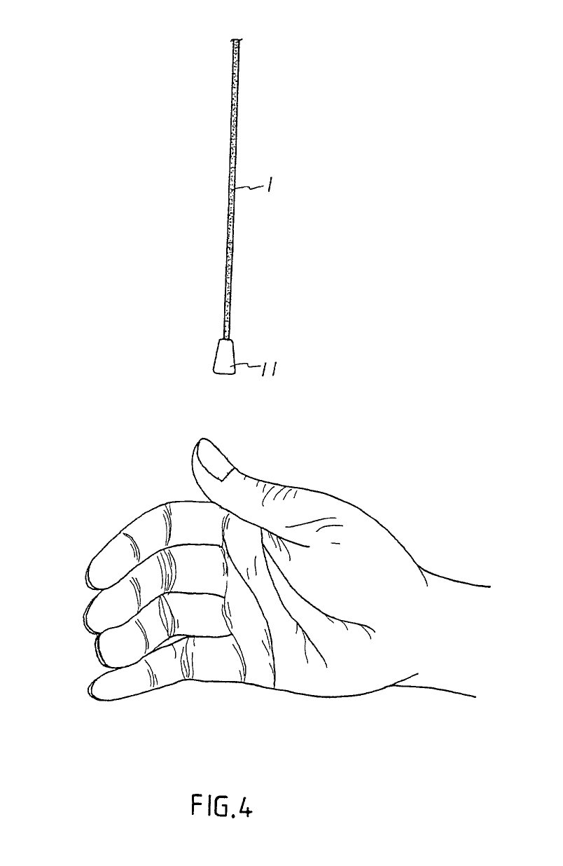

### DETAILED DESCRIPTION OF PREFERRED EMBODIMENTS

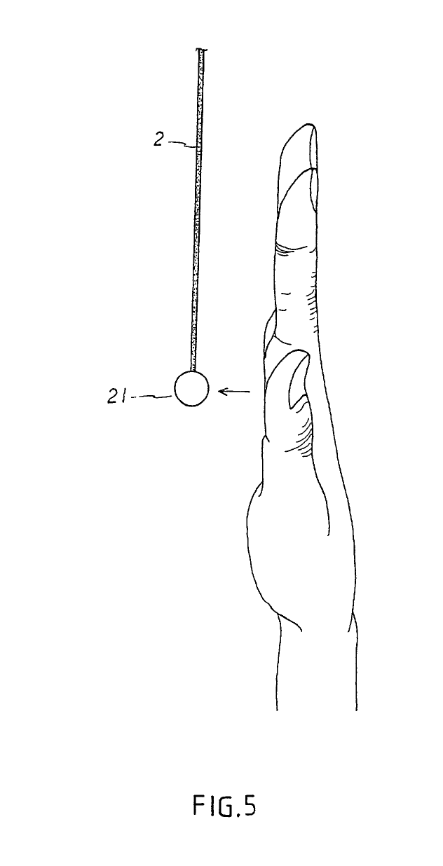

As shown in FIG. 5, the invention comprises a capacitive device and a suspension pull cord 2. The suspension pull cord 2 is a flexible cord. One end of the suspension pull cord 2 is connected to the capacitive sensor or device, so the suspension pull cord 2 becomes a touch or non-touch control cord with a capacitive induction effect. Thereby, the user can control the other end of the cord by touching one end of the suspension pull cord 2. Instead of grasping onto the suspension pull cord 2, control can be performed simply by touching or approaching the cord. The suspension pull cord 2 can be touched or approached in any direction to perform the control, which is very easy and convenient. Therefore, simply touching, patting or non-contact can perform the anticipated control effect and operation approaching. Meanwhile, there is no minimum requirement on the force being applied when the suspension pull cord is touched or patted to enable the control. Therefore, the switch will not be subjected to wear and tear or damage after it is in use for an extended period of time.

FIG. 6 shows another view of the invention with another characteristic. To avoid failure of performing anticipated control when a nonconductive insulator is used to touch the suspension pull cord 2′ (or when the user tries to touch the suspension cord using his gloved hand or a plastic ruler), the end of the suspension pull cord 2′ is attached with a touch unit 21, inside the touch unit 21 is suspended with a contact unit 22; the touch unit being hung by a grounded conductive wire 23 inside the hollow of the touch nit 21, the touch unit 21 and the contact unit 22 being separated and insulated from each other, with a thin clearance between the touch unit 21 and the contact unit 22. When the insulator touches the suspension pull cord 2′ or the touch unit 21, the suspension pull cord 2 and the touch unit 21 will vibrate or swing, enabling contact between the contact unit 22 and the touch unit 21, producing the effect of touch control. Therefore, in addition to the above functions and characteristics, the invention can also perform the effect of touch control, even when subjected to touch or contact by a nonconductive object.

Moreover, the touch control performed on the suspension pull cord 2 or 2′ can be varied by repetition of touches on the suspension pull cord 2 or 2′. As is often seen in the control of an electric ceiling fan, when the suspension pull cord 2 or 2′ is touched for the first time, the fan is rotated at an optional first speed. When the suspension pull cord 2 or 2′ is touched the second time, the fan is rotated at an optional second speed. Therefore, the same multiple-step control of a conventional suspension pull switch can also be performed in the present invention.

Optionally, to enable the user to see the suspension pull cord 2 or 2′ or the contact unit 21 at nighttime, the suspension pull cord 2 or 2′ or the touch unit 21 is coated with a fluorescent compound or a light-emitting object, or a lamp can be fitted. Meanwhile, to avoid damage to the invention of suspension pull cord 2 or 2′ as may be caused by frequent pulling, as is the practice employed on conventional pull switches, a buffer device can be installed between the conducting end of the suspension pull cord 2 or 2′ and the static induction control, so when the suspension pull cord 2 or 2′ is pulled, there will be no bad effect that may lead to damage.

To conclude, the invention uses a suspension cord with a pull switch for static induction control, which can improve the shortcomings in conventional pull switches, thereby performing the control by a single touch by the user. Therefore, this invention has satisfied the requirement for a patent right. Your favorable consideration will be appreciated.

What is claimed is:

1. An innovated suspension cord pull switch, having a capacitive induction effect terminal with a capacitive sensor or device, which is connected to one end of a suspension pull cord, so the suspension pull cord has a capacitive induction effect to perform the purpose of touch or non-touch control, without requiring a user to grasp the suspension pull cord, to aim at a specified direction, or to apply a specified minimum force.

2. The suspension cord pull switch as claimed in claim 1, wherein the capacitive induction effect is optionally replaced by a sensor or device activated by an electric current, impedance, a magnetic field, or a temperature setting.

3. The suspension cord pull switch as claimed in claim 1, wherein the suspension pull cord is optionally coated with a fluorescent compound or a light-emitting object, or fitted with a lamp.
